(19) United States
(12) Patent Application Publication
(10) Pub. No.: US 2015/0298480 A1
(43) Pub. Date: Oct. 22, 2015

(54) BASE PAPER FOR DECORATIVE LAMINATE AND DECORATIVE LAMINATE

(71) Applicant: KJ SPECIALTY PAPER CO., LTD., Shizuoka (JP)

(72) Inventors: Takuya Mizuno, Fuji-shi (JP); Akihiko Shibuya, Fuji-shi (JP)

(73) Assignee: KJ SPECIALTY PAPER Co., Ltd., Fuji-shi (JP)

(21) Appl. No.: 14/647,415

(22) PCT Filed: Nov. 27, 2013
(86) PCT No.: PCT/JP2013/081966

§ 371 Date: May 26, 2015

(30) Foreign Application Priority Data
Nov. 27, 2012 (JP) 2012-258772

(51) Int. Cl. B41M 5/52; D21H 17/00; D21H 17/54; D21H 19/12; D21H 17/67

(52) U.S. Cl. CPC B41M 5/5218; D21H 19/12; D21H 17/675; D21H 17/54; D21H 17/74

(57) ABSTRACT

A base paper for a decorative laminate has a hiding power and is produced without undergoing a sizing treatment. The base paper is used as a surface decorative material of a thermosetting resin decorative laminate. The hiding power refers to properties of hiding a hue of the background and hue unevenness when processed into a decorative laminate. In a base paper for a decorative laminate for inkjet printing, at least one neutral water-soluble metal salt selected from the group consisting of calcium chloride, magnesium chloride, magnesium sulfate and calcium acetate is externally added to at least a printing surface (front surface) in an amount of from 0.5 to 3.0 g/m² in terms of a dry adhesion amount (solid content) of the water-soluble metal salt.

### CROSS-REFERENCE TO RELATED PATENT APPLICATIONS

This application is a U.S. National Phase Application under 35 U.S.C. §371 of International Patent Application No. PCT/JP2013/081966, filed Nov. 27, 2013, and claims the benefit of Japanese Patent Application No. 2012-258772, filed on Nov. 27, 2012, all of which are incorporated by reference in their entirety herein. The International Application was published in Japanese on Jun. 5, 2014 as International Publication No. WO/2014/084280 under PCT Article 21(2).

### FIELD OF THE INVENTION

The present invention relates to a base paper for decorative laminate, which is used as a surface decorative material of a thermosetting resin decorative laminate such as a melamine decorative laminate, a polyester decorative laminate, and a DAP decorative laminate. In more detail, the present invention relates to a base paper for decorative laminate to be printed by inkjet printing.

### BACKGROUND OF THE INVENTION

As for a base paper for decorative laminate, on the occasion of molding, a filler such as titanium oxide, a pigment, or a dye, is incorporated thereinto according to a hue for the purpose of hiding a background. At this point, the base paper for decorative laminate is distinguished from an overlay base paper which is used for an outermost surface layer of the decorative laminate. The overlay base paper is required to be excellent in transparency on the occasion of molding.

The base paper for decorative laminate is roughly classified into a white base paper and a color base paper from the viewpoint of the hue thereof Although a hiding power of the base paper for decorative laminate is given chiefly by incorporating titanium oxide thereinto, the hiding power can also be given by the hue (by a pigment or a dye). As an extreme example, for example, titanium oxide is not incorporated into a black base paper for decorative laminate, and the hiding power is brought by incorporating a black pigment or a black dye thereinto. The hiding power as referred to in the present invention means properties of hiding a hue of the background and hue unevenness when processed into a decorative laminate.

In addition, from the viewpoint of printing, the base paper for decorative laminate is also roughly classified into a base paper for printing to which printing is applied and a base paper for single color which is used as is. A difference between the base paper for printing and the base paper for single color generally resides in setting up of smoothness of the base paper for decorative laminate. In the case of a printing application, a calender treatment is applied on the front surface side of the base paper for decorative laminate (the upper surface side in a wire part of a papermaking machine) by an on-machine calender installed in the papermaking machine. The smoothness (Oken type smoothness) on the front surface in the printing application is generally from 50 to 200 seconds, and printing is applied on the front surface side.

The titanium oxide comes out downward from the paper stock on the wire due to dehydration in the wire part of the papermaking machine, and therefore, the distribution amount of titanium oxide on the back surface is smaller than that on the front surface. In addition, the pigment or the like also comes out, and therefore, in the color base paper, the hue on the back surface is thinner than that on the front surface. From these facts, the back surface and the front surface of the base paper for decorative laminate can be distinguished from each other.

At all events, the base paper for decorative laminate in a state having been impregnated with a thermosetting resin is finally superimposed on other members, subjected to thermocompression molding, and processed into a decorative laminate. Accordingly, the base paper for decorative laminate is required to have impregnation suitability with the thermosetting resin. If the impregnation suitability with the thermosetting resin is poor, the productivity in the impregnation process is decreased. Incidentally, since the base paper for decorative laminate is impregnated with a large amount of the thermosetting resin, it is a special paper free from a sizing treatment, to which the sizing treatment with a sizing agent is not applied.

Printing with a wood-grain pattern, an abstract pattern, or the like on a base paper for decorative laminate for printing is applied for the purpose of bringing about design properties on the decorative laminate. Gravure printing is the main stream as a printing method. For the reason that the gravure printing is not suitable for small-quantity production or other reasons, the printing is also performed on the base paper for decorative laminate for printing by means of inkjet printing. However, even if the base paper for decorative laminate for printing as designed for gravure printing is diverted to a base paper for inkjet printing, a printing finish of the inkjet printing is not thoroughly satisfactory.

In order to improve the inkjet printing suitability of the base paper for decorative laminate, for example, JP-A-2007-211390 proposes to provide an ink-receiving layer on the front surface of the base paper for decorative laminate by means of coating. In order to provide the ink-receiving layer, after papermaking, a coating process is separately necessary. In the working examples of JP-A-2007-211390, an ink-receiving layer containing amorphous silica is provided on the front surface of a base paper for decorative laminate for single color. Incidentally, JP-A-2007-211390 does not mention the impregnation suitably of the thermosetting resin.

As for applications other than that for the base paper for decorative laminate, not only inkjet recording papers of a so-called coated paper type, in which an ink-receiving layer is provided, but also inkjet recording papers of a non-coated paper type, in which an ink-receiving paper is not provided, are investigated. The case where an ink-receiving layer is not provided is inexpensive from the standpoint of costs. For example, JP-B-H5-71393 and Japanese Patent No. 4034597 are exemplified.

Claim 1 of JP-B-H5-71393 recites: “An inkjet recording paper for water-soluble multicolor recording, which is characterized in that a support is coated or impregnated with a dimethyldiallylammonium chloride polymer and a monovalent or divalent water-soluble metal salt”. JP-B-H5-71393 also includes an inkjet recording paper of a coated paper type, and in the working examples, Example 3 is an example of an inkjet recording paper of a non-coated paper type. In Example 3, an impregnation liquid having PVA compounded therein is subjected to size-press impregnation.

Japanese Patent No. 4034597 is concerned with an inkjet recording paper for newspaper printing. In Japanese Patent No. 4034597, a water-soluble polyvalent metal salt is given by coating. It is mentioned that a water-soluble polymer binder such as starch and PVA may be used for a coating liquid.

All of the inkjet recording papers of JP-B-H5-71393 and Japanese Patent No. 4034597 are those subjected to an internally adding sizing treatment. Since these inkjet recording papers are subjected to an internally adding sizing treatment, they are not suitable for impregnation applications.

### SUMMARY OF THE INVENTION

Even in base papers for decorative laminate, a base paper for decorative laminate for inkjet printing that is more inexpensive and excellent in inkjet printing suitability is demanded.

The object of the present invention is to provide a base paper for decorative laminate for inkjet printing, to be printed by inkjet printing, the base paper for decorative laminate being related to a non-coated paper type, excellent in inkjet printing suitability, and also excellent in impregnation suitability with a thermosetting resin, and further a decorative laminate using the base paper for decorative laminate.

### Means for Solving Problem

The object of the present invention is achieved by externally adding at least one of calcium chloride, magnesium chloride, magnesium sulfate, and calcium acetate in an amount of from 0.5 to 3.0 g/m².

Specifically, the present invention is concerned with the following (1) to (5).

(1) A base paper for decorative laminate for inkjet printing, which is a base paper for decorative laminate having a hiding power and free from a sizing treatment,

wherein at least one neutral water-soluble metal salt selected from the group consisting of calcium chloride, magnesium chloride, magnesium sulfate and calcium acetate is externally added to at least a printing surface (front surface) to bear in an amount of from 0.5 to 3.0 g/m² in terms of a dry adhesion amount (solid content) of the water-soluble metal salt.

(2) The base paper for decorative laminate for inkjet printing as described in (1),

wherein titanium oxide is incorporated.

(3) The base paper for decorative laminate for inkjet printing as described in (1),

wherein a water-soluble binder is not externally added.

(4) A method for manufacturing a base paper for decorative laminate for inkjet printing, which is a method for manufacturing a base paper for decorative laminate having a hiding power and free from a sizing treatment, the method comprising:

conducting spray coating of at least one neutral water-soluble metal salt selected from the group consisting of calcium chloride, magnesium chloride, magnesium sulfate and calcium acetate from a printing surface side (front surface side) in a wet pressing process with a papermaking machine.

(5) A thermosetting resin decorative laminate, which uses, as a surface decorative material, a printed matter in which the printing surface of the base paper for decorative laminate for inkjet printing as described in (1) is subjected to inkjet printing.

The hiding power as referred to in the present invention means properties of hiding a hue of the background and hue unevenness when processed into a decorative laminate.

### Effects of Invention

According to the present invention, a base paper for decorative laminate for inkjet printing of a non-coated paper type, which is excellent in inkjet printing suitability and also excellent in impregnation suitability with a thermosetting resin, is provided. The present invention is applicable to any of white base papers and color base papers.

### DETAILED DESCRIPTION OF THE INVENTION

The present invention is hereunder described in due course.

In the present invention, raw materials and physical properties of the base paper for decorative laminate for inkjet printing are based on those of a conventional base paper for decorative laminate for printing and are not particularly limited. A basis weight of the base paper for decorative laminate for printing is generally in the range of 60 g/m² or more and 110 g/m² or less; an Oken type smoothness thereof is in the range of 50 seconds or more and 200 seconds or less; and though an Oken type air permeability thereof varies depending upon the paper weight in gsm and smoothness, it is generally in the range of 15 seconds or more and 30 seconds or less.

The base paper for decorative laminate for printing is obtained by subjecting a paper stock containing a pulp such as LBKP and NBKP (its freeness is preferably from 400 to 600 CSF), a filler depending upon the hue, such as titanium oxide and talc (incidentally, talc is weak in a hiding power as compared to titanium oxide), a pigment, a dye, and a variety of additives for paper manufacturing, such as a wet strengthening agent, aluminum sulfate, sodium aluminate, and a yield-improving agent, to papermaking by a fourdrinier paper machine or the like (incidentally, since the base paper for decorative laminate is highly impregnated with the thermosetting resin, it is a special paper free from a sizing treatment, to which the sizing treatment with a sizing agent, such as internal addition sizing and external addition sizing, is not applied). The base paper for decorative laminate for printing is subjected to a calender treatment and designed for formulation on the assumption of the calender treatment. An ash content of the white base paper for printing is generally 20% by mass or more and 40% by mass or less (substantially corresponding to titanium oxide).

The titanium oxide comes out downward from the paper stock on the wire due to dehydration in the wire part of the papermaking machine, and therefore, the distribution amount of titanium oxide on the back surface is smaller than that on the front surface. In addition, the pigment or the like also comes out, and therefore, in the color base paper, the hue on the back surface is thinner than that on the front surface. From these facts, the back surface and the front surface of the base paper for decorative laminate can be distinguished from each other.

As a method for externally adding at least one water-soluble metal salt of calcium chloride, magnesium chloride, magnesium sulfate and calcium acetate to at least a printing surface (front surface) of the base paper for decorative laminate, a known external addition method can be applied, and the method is not particularly limited. Not only coating using an air knife coater, a bar coater, a roll coater, or the like but also drenching impregnation can be applied as an external addition method which is performed by a separate process from the papermaking. On the occasion of papermaking, examples of the external addition method include spray coating by a wet press part and impregnation by a size press. On the occasion of papermaking, the external addition is preferred not only from the standpoint of costs but also in view of the fact that it is easy to control the hue and physical properties. Above all, in a process of the papermaking machine continuing from a wire part to a wet press part and then a dryer part, the spray coating by a wet press part on a wet paper is more preferred than the impregnation by a size press because the drying process is smaller.

Each of calcium chloride, magnesium chloride, magnesium sulfate and calcium acetate to be used in the present invention is a water-soluble metal salt having high solubility in water. In addition, an aqueous solution of each of four kinds of the water-soluble metal salts of the present invention is neutral. In general, what the aqueous solution is neutral means that the pH is 6.0 or more and 8.0 or less. Because of neutrality, the aqueous solution hardly influences moldability of the decorative laminate such as molding time and surface hardness.

In the present invention, an amount of externally adding the water-soluble metal salt to the base paper for decorative laminate is preferably in the range of 0.5 g/m² or more and 3.0 g/m² or less in terms of a dry adhesion amount (solid content). When the dry adhesion amount of the water-soluble metal salt is too small, there is a tendency that sufficient color developability is not obtained. When the dry adhesion amount of the water-soluble metal salt is too large, there is a tendency that the impregnation suitability with a thermosetting resin is deteriorated.

Since there is a concern that the water-soluble polymer binder such as starch and PVA deteriorates the impregnation suitability with a thermosetting resin, in the present invention, it is preferred not to blend the water-soluble polymer binder into the coating liquid or impregnation liquid of the water-soluble metal salt.

In the thus-obtained base paper for decorative laminate for inkjet printing of the present invention, the printing surface thereof is subjected to printing by means of inkjet printing. An inkjet printing method is not particularly limited. An ink is not particularly limited, too, and for example, all of solvent-based pigment inks and aqueous pigment inks may be used as the pigment ink.

The printed matter having been subjected to printing by means of inkjet printing can be processed into a thermosetting resin decorative laminate as a surface decorative material by a known method. The decorative laminate to be obtained is not particularly limited, and it can be used as a surface decorative material of a high-pressure melamine decorative laminate, a low-pressure melamine decorative laminate, a polyester decorative laminate, or a DAP decorative laminate.

### EXAMPLES

The present invention is hereunder described in detail by reference to Examples, and all parts and % represent parts by mass and % by mass, respectively.

### <Base Paper for Decorative Laminate Working as a Base>

In the present Examples, a product number KSH-801P that is a white base paper for printing of an 80 g/m² product, manufactured by KJ Specialty Paper Co., Ltd. was used as a base paper for decorative laminate working as a base of a base paper for decorative laminate for inkjet printing. The used KSH-801P had a basis weight of 80 g/m², a smoothness (Oken type smoothness) of 120 seconds, an air permeability (Oken type air permeability) of 25 seconds, and an ash content of 32% (substantially corresponding to a content of titanium oxide). Incidentally, KSH-801P is subjected to papermaking by a fourdrinier paper machine having a fourdrinier, a multi-cylinder dryer, and an on-machine calender.

The present Examples and Comparative Examples were evaluated in the following methods.

(1) Impregnation Suitability with Thermosetting Resin:

As for the impregnation suitability with a thermosetting resin, a 55% aqueous solution of a melamine resin which is used for a high-pressure melamine decorative laminate was used as the thermosetting resin, regulated to 20° C., and then permeated from the front surface of a paper; visual observation was performed until the melamine resin uniformly permeated into the back surface of the paper; and a required time was measured by a stopwatch. The lower the numerical value, the more excellent the impregnation suitability with the melamine resin is. Taking into consideration the impregnation time of uncoated KSH-801P, in the present invention, the required time of 100 seconds or less, and more preferably 50 seconds or less was determined to be favorable.

### (2) Inkjet Printing Suitability:

### <Evaluation of Color Developability>

PX-V630 (manufactured by Seiko Epson Corporation) was used for an inkjet printer, and the front surface (printing surface) was subjected to purple solid printing with genuine aqueous pigment inks. A hue of the printed matter was measured by colorimetry with a Macbeth spectrophotometer, CE-3100 (manufactured by Sakata Inx Corporation). When an a-value is higher in the hue, it is exhibited that the color development of a red ink is good. In the present invention, the case where the a-value is 20 or more was determined to be excellent in the color developability.

### <Evaluation of Sharpness>

The sharpness was evaluated by observing a dot diameter by a microscope, VHX-500 (manufactured by Keyence Corporation). The smaller the dot diameter, the sharper the image is. In the present invention, the case where the dot diameter is 60 μm or less was determined to be excellent in the sharpness.

### (3) Evaluation of Finish of Decorative Laminate:

The printed matter printed in the above-described (2) was molded into a decorative laminate by the following method, and a hue of the decorative laminate was subjected to colorimetry with a Macbeth spectrophotometer, CE-3100 (manufactured by Sakata Inx Corporation). In the present invention, the case where an a-value is 20 or more was determined to be excellent in the finish of printing when processed into a decorative laminate.

### <Fabrication of Decorative Laminate>

A printed matter was subjected to drenching impregnation with a 55% melamine resin impregnation liquid resulting from dissolving 100 parts of a melamine resin that is used for a high-pressure melamine decorative laminate, 0.2 parts of a curing agent, and 1 part of a penetrant in water, thereby obtaining a melamine resin-impregnated paper having a rate of impregnation of from 100% to 130% on the printed mattebasis.

Subsequently, four sheets of core papers impregnated with a phenol resin, manufactured by Ohta Sangyo K.K. were superimposed on an overlay paper impregnated with a melamine resin, manufactured by Ohta Sangyo K.K.; furthermore, the above-described printed matter impregnated with a melamine resin impregnation liquid was placed thereon; and moreover, an overlay paper impregnated with a melamine resin, manufactured by Ohta Sangyo K.K. was placed thereon, followed by heat pressurization with a heat pressurizing pressing machine to obtain a high-pressure melamine decorative laminate.

### Example 1

A 1% aqueous solution of calcium chloride (manufactured by Wako Pure Chemicals Industries, Ltd.) was prepared. A white base paper for printing, KSH-801P was impregnated with this aqueous solution (pH=7.4) as an impregnation liquid. A dry adhesion amount was 0.6 g/m².

### Example 2

A 4% aqueous solution of calcium chloride (manufactured by Wako Pure Chemicals Industries, Ltd.) was prepared. A white base paper for printing, KSH-801P was impregnated with this aqueous solution (pH=7.7) as an impregnation liquid. A dry adhesion amount was 2.0 g/m².

### Example 3

A 4% aqueous solution of magnesium chloride (manufactured by Wako Pure Chemicals Industries, Ltd.) was prepared. A white base paper for printing, KSH-801P was impregnated with this aqueous solution (pH=7.6) as an impregnation liquid. A dry adhesion amount was 2.6 g/m².

### Example 4

A 4% aqueous solution of magnesium sulfate (manufactured by Wako Pure Chemicals Industries, Ltd.) was prepared. A white base paper for printing, KSH-801P was impregnated with this aqueous solution (pH=7.5) as an impregnation liquid. A dry adhesion amount was 2.1 g/m².

### Example 5

A 4% aqueous solution of calcium acetate (manufactured by Wako Pure Chemicals Industries, Ltd.) was prepared. A white base paper for printing, KSH-801P was impregnated with this aqueous solution (pH=7.1) as an impregnation liquid. A dry adhesion amount was 1.9 g/m².

### Example 6

100 parts of a broad-leaved tree bleached kraft pulp (LBKP) was subjected to refining to a degree of 400 mlCSF by using a double disc refiner. To this, 60 parts of titanium oxide, an inorganic coagulant, and a wet strengthening agent, polyacrylamide epichlorohydrin were added, and the mixture was regulated to a pH of 8.3 with sodium aluminate. This was used as a processing species and subjected to hand-made papermaking by a hand-made paper sheet forming machine, and an 8% aqueous solution of calcium chloride (manufactured by Wako Pure Chemicals Industries, Ltd.) (pH=7.7) was sprayed onto a wet paper sheet formed on the wire, thereby obtaining a paper having a paper weight in gsm of 81.9 g/m² and an ash content of 34%. At that time, a dry adhesion amount of calcium chloride was 0.8 g/m².

### Comparative Example 1

A commercially available inkjet paper of a non-coated paper type (double-sided high-quality plain paper for exclusive use for inkjet, manufactured by Seiko Epson Corporation) was made as Comparative Example 1.

### Comparative Example 2

A white base paper for printing, KSH-801P was made as a base paper for decorative laminate of Comparative Example 2.

### Comparative Example 3

A 0.5% aqueous solution of calcium chloride (manufactured by Wako Pure Chemicals Industries, Ltd.) (pH=7.2) was prepared. A white base paper for printing, KSH-801P was impregnated with this aqueous solution as an impregnation liquid. A dry adhesion amount was 0.3 g/m².

### Comparative Example 4

An 8% aqueous solution of magnesium sulfate (manufactured by Wako Pure Chemicals Industries, Ltd.) (pH=7.6) was prepared. A white base paper for printing, KSH-801P was impregnated with this aqueous solution as an impregnation liquid. A dry adhesion amount was 5.1 g/m².

### Comparative Example 5

A 4% aqueous solution of sodium sulfate (manufactured by Wako Pure Chemicals Industries, Ltd.) was prepared. A white base paper for printing, KSH-801P was impregnated with this aqueous solution (pH=7.5) as an impregnation liquid. A dry adhesion amount was 1.8 g/m².

### Comparative Example 6

100 parts of a broad-leaved tree bleached kraft pulp (LBKP) was subjected to refining to a degree of 400 mlCSF by using a double disc refiner. To this, 50 parts of talc, an inorganic coagulant, and a wet strengthening agent, polyacrylamide epichlorohydrin were added, and the mixture was regulated to a pH of 8.3 with sodium aluminate. This was used as a processing species and subjected to hand-made papermaking by a hand-made paper sheet forming machine, thereby obtaining a base paper having a paper weight in gsm of 79.5 g/m² and an ash content of 28%.

This paper was impregnated with the same impregnation liquid as in Example 4. A dry adhesion amount was 1.8 g/m².

### Comparative Example 7

100 parts of a broad-leaved tree bleached kraft pulp (LBKP) was subjected to refining to a degree of 400 mlCSF by using a double disc refiner. To this, 60 parts of titanium oxide, an inorganic coagulant, and a wet strengthening agent, polyacrylamide epichlorohydrin were added, and the mixture was regulated to a pH of 8.3 with sodium aluminate, to which was then further added 8 parts of magnesium sulfate (manufactured by Wako Pure Chemicals Industries, Ltd.). This was used as a processing species and subjected to hand-made papermaking by a hand-made paper sheet forming machine, thereby obtaining a paper having a paper weight in gsm of 78.5 g/m² and an ash content of 33%.

### Comparative Example 8

10 parts of a needle-leaved tree bleached kraft pulp (NBKP) and 90 parts of a broad-leaved tree bleached kraft pulp (LBKP) were subjected to refining to a degree of 470 mlCSF by using a double disc refiner. To this, 10 parts of calcium carbonate, 0.8 parts of amphoteric starch, 0.6 parts of aluminum sulfate, an internally adding sizing agent, AS-263 (manufactured by Arakawa Chemical Industries, Ltd.), and a wet strengthening agent, polyacrylamide epichlorohydrin were added. This was used as a processing species and subjected to hand-made papermaking by a hand-made paper sheet forming machine, thereby obtaining a paper having a paper weight in gsm of 82.0 g/m² and an ash content of 6.0%.

This paper was impregnated with a 6% aqueous solution of magnesium sulfate (manufactured by Wako Pure Chemicals Industries, Ltd.) (pH=7.6) as an impregnation liquid. A dry adhesion amount was 1.1 g/m². Comparative Example 8 assumes a general inkjet paper of a non-coated paper type (the base paper for decorative laminate is a special paper free from a sizing treatment, to which the sizing treatment with a sizing agent is not applied).

The evaluation results of Examples 1 to 5 are shown in Table 1, and the evaluation results of Example 6 are shown in Table 2.

TABLE 1

| | | Example | | | | |
|---|---|---|---|---|---|---|
| | | 1 | 2 | 3 | 4 | 5 |
| Impregnation | Impregnating | Calcium | Calcium | Magnesium | Magnesium | Calcium |
| | agent | chloride | chloride | chloride | sulfate | acetate |
| | Liquid con- | 1 | 4 | 4 | 4 | 4 |
| | centration (%) | | | | | |
| | Dry adhesion | 0.6 | 2.0 | 2.6 | 2.1 | 1.9 |
| | amount (g/m²) | | | | | |
| Impregnation suitability with | | 22 | 16 | 20 | 45 | 24 |
| thermosetting resin (sec) | | | | | | |
| Inkjet printing | Color | 21 | 25 | 24 | 22 | 23 |
| suitability | developability | | | | | |
| | (a-value) | | | | | |
| | Sharpness (μm) | 60 | 55 | 50 | 55 | 60 |

| | | | | | |
|---|---|---|---|---|---|
| Evaluation of finish of decorative | 22 | 27 | 26 | 24 | 22 |
| laminate (a-value) | | | | | |

TABLE 2

| | | Example |
|---|---|---|
| | | 6 |
| Spraying onto wet | Spraying liquid | Calcium chloride |
| paper on wire | Liquid concentration (%) | 8 |
| | Dry adhesion amount (g/m²) | 0.8 |
| Impregnation suitability with | | 17 |
| thermosetting resin (sec) | | |
| Inkjet printing | Color developability (a-value) | 21 |
| suitability | Sharpness (μm) | 58 |

| | |
|---|---|
| Evaluation of finish of decorative laminate (a-value) | 22 |

The evaluation results of Comparative Example 1 are shown in Table 3; the evaluation results of Comparatives Examples 2 to 5 are shown in Table 4; the evaluation results of Comparative Example 6 are shown in Table 5; the evaluation results of Comparative Example 7 are shown in Table 6; and the evaluation results of Comparative Example 8 are shown in Table 7.

TABLE 3

| | | Comparative Example |
|---|---|---|
| | | 1 |
| | | Commercially available |
| | | inkjet paper of non- |
| | | coated paper type |
| Impregnation suitability with | | 180< |
| thermosetting resin (sec) | | |
| Inkjet printing suitability | Color developability | 21 |
| | (a-value) | |
| | Sharpness (μm) | 60 |

| | |
|---|---|
| Evaluation of finish of decorative | 13 |
| laminate (a-value) | |

TABLE 4

| | | Comparative Example | | | |
|---|---|---|---|---|---|
| | | 2 | 3 | 4 | 5 |
| Impregnation | Impregnating | Nil | Calcium | Magnesium | Sodium |
| | agent | | chloride | sulfate | sulfate |
| | Liquid | — | 0.5 | 10 | 4 |
| | concentration | | | | |
| | (%) | | | | |
| | Dry adhesion | — | 0.3 | 5.1 | 1.8 |
| | amount (g/m²) | | | | |
| Impregnation suitability with | | 25 | 26 | 180< | 143 |
| thermosetting resin (sec) | | | | | |
| Inkjet printing | Color | 6.3 | 18 | 24 | 9.3 |
| suitability | developability | | | | |
| | (a-value) | | | | |
| | Sharpness (μm) | 80 | 65 | 50 | 70 |

| | | | | |
|---|---|---|---|---|
| Evaluation of finish of | 6.5 | 19 | 26 | 12 |
| decorative laminate (a-value) | | | | |

TABLE 5

| | | Comparative Example |
|---|---|---|
| | | 6 |
| | | Hand-made sheet not using |
| | | titanium oxide |
| Impregnation | Impregnating agent | Magnesium sulfate |
| | Liquid concentration (%) | 4 |
| | Dry adhesion amount (g/m²) | 1.8 |
| Impregnation suitability with thermosetting | | 15 |
| resin (sec) | | |
| Inkjet | Color developability (a-value) | 20 |
| printing | Sharpness (μm) | 60 |
| suitability | | |

| | |
|---|---|
| Evaluation of finish of | 7.8 |
| decorative laminate (a-value) | |

TABLE 6

| | | Comparative Example |
|---|---|---|
| | | 7 |
| | | Magnesium |
| | | sulfate-internally added |
| | | hand-made sheet |
| Internal | Internal additive | Magnesium sulfate |
| additive | Addition amount (parts by | 8 |
| | mass) | |
| Impregnation suitability with | | 13 |
| thermosetting resin (sec) | | |
| Inkjet printing | Color developability (a-value) | 11 |
| suitability | Sharpness (μm) | 75 |

| | |
|---|---|
| Evaluation of finish of decorative | 13 |
| laminate (a-value) | |

TABLE 7

| | | Comparative Example |
|---|---|---|
| | | 8 |
| | | Hand-made sheet assuming |
| | | general non-coated paper |
| | | type |
| Impregnation | Impregnating agent | Magnesium sulfate |
| | Liquid concentration (%) | 6 |
| | Dry adhesion amount (g/m²) | 1.1 |
| Impregnation suitability with | | 180< |
| thermosetting resin (sec) | | |
| Inkjet | Color developability | 23 |
| printing | (a-value) | |
| suitability | Sharpness (μm) | 40 |

| | |
|---|---|
| Evaluation of finish of decorative | 11 |
| laminate (a-value) | |

It is understood from the results of Tables 1 to 7 that Examples 1 to 6 falling within the scope of the present invention are excellent in the inkjet printing suitability, excellent in the impregnation suitability with a thermosetting resin, and favorable in the finish of printing when processed into a decorative laminate. In Comparative Example 1, it is understood that the impregnation suitability with a thermosetting resin is inferior, and a hiding power as a base paper for decorative laminate is not revealed, and therefore, when processed into a decorative laminate, the finish of printing is poor.

In Comparative Example 3, it is understood that the amount of the water-soluble metal salt is insufficient, so that favorable color developability is not obtained. In Comparative Example 4, it is understood that the amount of the water-soluble metal salt is too large, so that the impregnation suitability with a thermosetting resin is poor. In Comparative Example 5, it is understood that in sodium sulfate that is other water-soluble metal salt, not only sufficient color developability is not obtained, but also the impregnation suitability with a thermosetting resin is deteriorated.

In Comparative Example 6, it is understood that even when talc is incorporated into the base paper for decorative laminate, a hiding power by talc is weak when processed into a decorative laminate, and therefore, when processed into a decorative laminate, the finish of printing is poor.

In Comparative Example 7, it is understood that though magnesium sulfate was internally added, all of the color developability, the sharpness, and the finish of printing when processed into a decorative laminate are poor.

Though Comparative Example 8 assumes a general inkjet paper of a non-coated paper type, it is understood that the impregnation suitability with a thermosetting resin is poor, and a hiding power as a base paper for decorative laminate is not revealed, and therefore, when processed into a decorative laminate, the evaluation of finish of printing is poor.

### INDUSTRIAL APPLICABILITY

The base paper for decorative laminate of the present invention is excellent in inkjet printing suitability and also excellent in impregnation suitability with a melamine resin, and therefore, its utilization for a high-pressure melamine decorative laminate using an inkjet printed matter as a surface decorative material can be expected. In addition, the base paper for decorative laminate of the present invention can be expected to be developed into not only the high-pressure melamine decorative laminate but also a low-pressure melamine decorative laminate, a polyester decorative laminate, and a DAP decorative laminate.

1. A base paper for a decorative laminate for inkjet printing, comprising:
a base paper having a hiding power and being free from a sizing treatment,
wherein the base paper has a thermosetting resin impregnated therein to be used for a thermosetting resin decorative laminate, and
an aqueous solution, which contains at least one neutral water-soluble metal salt selected from the group consisting of calcium chloride, magnesium chloride, magnesium sulfate and calcium acetate but does not contain a water-soluble binder, is externally added to at least a printing surface (front surface) of the base paper in an amount of from 0.5 to 3.0 g/m² in terms of a dry adhesion amount (solid content) of the water-soluble metal salt.

2. The base paper for decorative laminate for inkjet printing according to claim 1, wherein titanium oxide is incorporated.

3. (canceled)

4. A method for manufacturing a base paper for decorative laminate for inkjet printing, which is a method for manufacturing a base paper for a decorative laminate having a hiding power and being free from a sizing treatment, the method comprising the steps of:
spray coating an aqueous solution which contains at least one neutral water-soluble metal salt selected from the group consisting of calcium chloride, magnesium chloride, magnesium sulfate and calcium acetate but does not contain a water-soluble binder onto a printing surface (front surface) of the base paper in a wet pressing process with a papermaking machine in an amount of from 0.5 to 3.0 g/m² in terms of a dry adhesion amount (solid content) of the water-soluble metal salt, and
impregnating the base paper with a thermosetting resin to be used for a thermosetting resin decorative laminate.

5. A thermosetting resin decorative laminate, which uses, as a surface decorative material, a printed matter in which the printing surface of the base paper according to claim 1 is subjected to inkjet printing.

6. The base paper for a decorative laminate for inkjet printing according to claim 1, wherein titanium oxide is incorporated in an amount of 20% by mass or more.
